(19) United States
(12) Patent Application Publication
(10) Pub. No.: US 2018/0264787 A1
(43) Pub. Date: Sep. 20, 2018

(54) MULTILAYER FOOD CASING OR FOOD FILM

(71) Applicant: E I DU PONT DE NEMOURS AND COMPANY, Wilmington, DE (US)

(72) Inventors: Karlheinz Hausmann, Auvernier (CH); Yves M. Trouilhet, Vesenaz (CH); Camille Olry, Viry (FR); Heiko E. Schenck, Leipzig (DE)

(21) Appl. No.: 15/516,558

(22) PCT Filed: Sep. 29, 2015
(86) PCT No.: PCT/US2015/052818

§ 371 Date: Apr. 3, 2017

Related U.S. Application Data
(60) Provisional application No. 62/059,211, filed on Oct. 3, 2014.

(51) Int. Cl. B32B 27/08; B32B 1/08; B32B 7/12; B32B 27/30; B32B 27/32; B32B 27/34; B32B 27/36

(52) U.S. Cl. CPC B32B 27/08; B32B 1/08; B32B 7/12; B32B 27/306; B32B 27/308; B32B 27/32; B29L 2031/712; B32B 27/36; B32B 2250/24; B32B 2307/7244; B32B 2307/7246; B32B 2439/70; B29K 2995/0067; B32B 27/34

(57) ABSTRACT

Disclosed is a multilayer biaxially oriented sheet- or tube-type food casing or food packaging film comprising in order from outside to inside an outside surface layer preferably comprising polyester; a gas barrier layer preferably comprising ethylene vinyl alcohol copolymer positioned so that at least 60% of the total film thickness is to the inside of the gas barrier layer with respect to a package prepared from the film; an optionally shrinkable forming layer comprising polyolefins or ethylene copolymers; and an inside surface layer comprising polyethylene homopolymer or an ethylene alkyl (meth)acrylic acid copolymer or ionomer thereof. The casing or film can be produced by a blown film process and biaxially oriented by a triple-bubble process or by cast film process and biaxially oriented by a tenter frame process.

### FIELD OF THE INVENTION

The invention relates to an optionally shrinkable multilayer two-dimensional food packaging film or tubular food casing that is produced by a blown film process and biaxially oriented by a triple-bubble process or by cast film process and biaxially oriented by a tenter frame process, for food packaging such as, e.g., shrink bags, sealable films, wrapping films or the like.

### BACKGROUND

Coextruded multilayer film structures are complex assemblies that may require careful combination of multiple functional layers in order to achieve a desired end-product. Generally, they require the ability to form a tight seal, such as by heat-sealing, around the packaged goods or to allow fabrication into pouches or other packaging forms. Multilayer films are often used for packaging various food products and may require barriers to oxygen and moisture penetration to extend the useful shelf life of the packaged goods. They may also require the ability to shrink around the packaged product to provide a form-fitting package. The films may be in the form of two-dimensional generally planar thin films, or they may be tubular films.

In practice, many such multilayered tubular or two-dimensional packaging films are already used in the form of 5- or 7-layered films.

For example, EP0236099 B2 discloses a multilayered tubular packaging film for foodstuffs, referred to as a packaging oxygen barrier film, having up to 7 layers. The external layer comprises a polyolefin (PO) that provides good protection against humidity for the inner layers but does not have a clearly enhanced temperature resistance in comparison with the seal layer.

EP0476836 B1 discusses a 6-layer packaging film that contains a temperature-resistant external layer of PET, with core layers comprising EVOH and PA for oxygen barrier and mechanical strength that are not protected against humidity by a separate, pure PO layer.

EP1034076 B1 also discloses a heat-shrinkable thermoplastic multilayered packaging film having a temperature-resistant external layer comprising polyamide (PA) that does not have any PO layer as a water vapor barrier from the outside.

WO2005/011978 A1 discloses a 5-layer packaging film having a temperature-resistant external layer of PET and a core layer of EVOH for an oxygen barrier. But here, too, no humidity barrier from the outside is provided. The films disclosed therein are manufactured not by a blown film process with biaxial orientation (triple-bubble process) but by a flat tape process with biaxial orientation (tenter-frame process).

EP1993809 B1 discloses a multilayer film comprising an outer surface layer including a polyester resin or a polyolefin resin, an intermediate layer including a polyamide resin, and a heat-sealing inner surface layer including a polyolefin resin or a mixture of polyolefin resins.

DE 102 54 172 A1 and DE 102 27 580 A1 also disclose similar structures of 7-layered packaging films, on the one hand with PO in the external layer as a water vapor barrier, or on the other hand with PET in the external layer as a temperature-resistant layer.

US Patent Application Publication 2014/0044902 discloses a multilayer film comprising at least nine layers of which an EVOH layer has the form of an oxygen barrier symmetrically embedded between two PA layers intended to impart strength and in turn symmetrically enclosed by two PO layers for a water vapor barrier, and wherein the external layer is formed by a highly temperature-resistant material such as PET.

Accordingly it is desirable to develop a multilayered two-dimensional or tubular food casing or food film in such a way that a sufficiently high oxygen barrier may be provided with a concurrently high water vapor barrier and with excellent mechanical strength, excellent optical properties, good suitability for further processing, high temperature resistance of the external layer, and a satisfactory shrinkage rate, while avoiding the above-discussed drawbacks.

### SUMMARY OF THE INVENTION

This invention relates to an optionally shrinkable multilayer food casing or food packaging film comprising the following layer structure positioned in order from the outside to the inside:

an outside surface layer comprising or consisting essentially of polyester, polyamide, polystyrene, polycarbonate, poly(methyl methacrylate), cyclic olefin copolymer, polypropylene, high density polyethylene, or combinations thereof, preferably polyester such as polyethylene terephthalate;

an optional layer comprising a first adhesion layer;

a gas barrier layer comprising or consisting essentially of ethylene vinyl alcohol copolymer, cyclic olefin copolymers, polyvinyl acetate, or blends thereof with polyethylene, polyvinyl alcohol, or polyamide; preferably ethylene vinyl alcohol copolymer; positioned so that at least 60%, preferably at least 65%, of the total film thickness is to the inside of the gas barrier layer with respect to a package prepared from the film;

an optional layer comprising a second adhesion layer;

an optionally shrinkable forming layer comprising or consisting essentially of polyethylene homopolymer or copolymer, polypropylene homopolymer or copolymer, or an ethylene copolymer comprising copolymerized units derived from ethylene and at least one additional polar comonomer, preferably ethylene vinyl acetate copolymer, ethylene alkyl (meth)acrylate copolymer, ethylene alkyl (meth)acrylic acid copolymer or ionomer thereof, or combination of two or more thereof, and more preferably an ionomer;

an optional layer comprising a third adhesion layer; and

an inside surface layer comprising or consisting essentially of polyethylene homopolymer or copolymer, or an ethylene alkyl (meth)acrylic acid copolymer or ionomer thereof; preferably an ionomer.

An embodiment includes a structure comprising

a first layer comprising an outside surface layer as described above;

a second layer comprising an adhesion layer;

a third layer comprising polyamide;

a fourth layer comprising EVOH;

a fifth layer comprising polyamide;

a sixth layer comprising an adhesion layer;

a seventh layer comprising an ionomer or polyethylene;

an optional eighth layer comprising an adhesion layer; and

a ninth (inside surface) layer comprising a polyolefin or an ionomer.

The food casing or food film as described above may have the shape of a sheet or a tube which is produced by a blown film coextrusion process and biaxially oriented by the triple-bubble process or by a cast film coextrusion process and biaxially oriented by tenter frame orientation.

The coextruded and oriented (mono- or preferably bi-axially oriented) multilayer structure described above can be produced in a triple bubble process, wherein the process comprises, or consists essentially of, coextruding a multilayer molten flow comprising the layer structure described above; cooling the multilayer film structure in a first bubble to produce a tubular multilayer structure; orienting the tubular multilayer structure under heating in a second bubble to produce an oriented tubular multilayer structure; and relaxing the oriented tubular multilayer structure under heating in a third bubble.

The invention also provides a process for preparing the food casing or food film as described above comprising, or consisting essentially of, coextruding in a flat die a multilayer molten flow comprising the layer structure according to any of the preceding claims; cooling the multilayer film structure on a casting roll to produce a multilayer flat structure; orienting the multilayer structure under heating in an oven of a tenter frame to produce an oriented multilayer structure; and relaxing the oriented flat multilayer structure under heating in an oven of a tenter frame.

Also provided is an article comprising the multilayer food casing or food packaging film structure, including a packaging article such as a shrink bag, sealable film, wrapping film, pouch or the like.

### DETAILED DESCRIPTION OF THE INVENTION

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, the terms “a” and “an” include the concepts of “at least one” and “one or more than one”. The word(s) following the verb “is” or “are” can be a definition of the subject.

The term “consisting essentially of” in relation to film layer materials is to indicate that substantially (greater than 95 weight % or greater than 99 weight %) the only polymer(s) present in a component layer is the polymer(s) recited. Thus this term does not exclude the presence of additives, e.g. conventional film additives; i.e. each layer independently may contain conventional film additives such those described below. Moreover, such additives may possibly be added via a masterbatch that may include other polymers as carriers, so that minor amounts (less than 5 or less than 1 weight %) of polymers other than those recited may be present, wherein these minor amounts do not change the basic and novel characteristics of the invention.

When the term “about” is used in describing a value or an end-point of a range, the disclosure should be understood to include the specific value or end-point referred to.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present). When present an optional component may be at least 0.1 weight % of the composition or copolymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers or to the amounts of its constituent comonomers such as, for example “a copolymer comprising ethylene and 15 weight % of acrylic acid”. A description of a copolymer with reference to its constituent comonomers or to the amounts of its constituent comonomers means that the copolymer contains copolymerized units (in the specified amounts when specified) of the specified comonomers. Polymers having more than two types of monomers, such as terpolymers, are also included within the term “copolymer” as used herein. A dipolymer consists of two copolymerized comonomers and a terpolymer consists of three copolymerized comonomers.

“(Meth)acrylic acid” includes methacrylic acid and/or acrylic acid and “(meth)acrylate” includes methacrylate and/or acrylate. Alkyl (meth)acrylate refers to alkyl acrylate and/or alkyl methacrylate.

The term “when exposed (or heated) to a temperature of” refers to the temperature of the environment around the film such as the temperature of an oven in which the film is placed or the temperature of an oil or water bath in which the film is placed. It will be appreciated that if the film is present in an oven for a short period of time, the film itself may not heat to the oven temperature. For ease of measurement however, “when exposed to a temperature” refers to the temperature of the environment rather than the actual film temperature.

The term “outside” as used herein refers to the side of the packaging film that faces away from the contents of a package made from the film. When used to define the position of a layer in relation to another layer in the multilayer packaging film, “outside” refers to layer(s) farther away from the contents of the package than another layer, even if neither layer is a surface layer. Likewise, the term “inside” refers to the side of the packaging film that faces toward the contents of a package made from the film. When used to define the position of a layer in relation to another layer in the multilayer packaging film, “inside” refers to the layer(s) closer to the contents of the package than another layer, even if neither layer is a surface layer. A surface layer has only one face of the layer in contact with another layer. The term “outside surface layer” refers to the surface layer farthest away from the contents of a package made from the film and the term “inside surface layer” refers to the surface layer closest to the contents of a package made from the film.

The term “forming layer” is used herein to refer to a layer whose function is to provide retraction of the multilayer structure when exposed to a temperature, including a layer or layers that control the amount of shrinkage for the overall film depending on the level of orientation and/or ability to relax when exposed to a temperature above the melting point of the composition used in the forming layer.

The invention provides a multilayered two-dimensional or tubular food casing or food film which is in particular produced by a circular die extrusion process and optionally biaxially oriented by the triple-bubble process, for food packaging such as, e.g., shrink films, sealable films, lidding films, wrapping films or the like, characterized by the following structure including (from the outside to the inside) at least a protective external layer, a gas barrier layer, an optionally shrinkable forming layer and a sealant layer. Depending on the compositions of the various functional layers, additional optional layers include adhesion layers that provide good adhesion between the functional layers. For example, adhesion layers may be positioned between the external layer and the gas barrier layer, between the gas barrier layer and the forming layer, and/or between the forming layer and the sealant layer.

For the external layer, polyesters such as polyethylene terephthalate (PET) provide excellent optical properties, such as gloss and transparency, and provide a high speed of further processing (cycle numbers) due to the high temperature resistance. EVOH advantageously forms the desired oxygen barrier. Ionomer or polyethylene compositions provide the desired mechanical properties for the forming layer and are also suitable for the sealant layer.

External Layer

The outside surface layer, or external layer, of the food casing or food film provides the outside layer of a package and is the layer farthest from the packaged contents.

The outside layer may comprise polyester, polyamide (PA), polystyrene (PS), polycarbonate (PC), poly(methyl methacrylate) (PMMA), cyclic olefin copolymer (COC), polypropylene (PP), polyethylene (PE) or combinations thereof, providing for the ability to weld or seal the films by extremely high temperatures without the film being bonded to the welder terminal. As a result, higher cycle numbers may be achieved on the welding machines. In addition the film is substantially less sensitive to external injury and possesses excellent optical properties such as gloss and transparency. Furthermore the film is particularly well suited for inscribing or printing.

Preferably, the external layer comprises or consists essentially of polyester, notably PET.

Alternatively, the external layer comprises polyamide. When the external layer comprises polyamide, it may also function as one of the polyamide layers that “sandwich” an EVOH oxygen barrier layer, as described more fully below.

Alternatively, the external layer comprises polypropylene or polyethylene, preferably high density polyethylene (HDPE). When the external layer comprises PP or PE, it may provide a good barrier to moisture permeating from the exterior of the package.

Gas Barrier Layer

The films also comprise a gas barrier layer. The term “gas barrier layer” as used herein denotes a film layer that allows transmission through the film of less than 1000 cc of gas, such as oxygen, per square meter of film per 24 hour period at 1 atmosphere and at a temperature of 73° F. (23° C.) at 50% relative humidity. Preferably the barrier layer provides for oxygen transmission below 500, below 100, below 50, below 30 or below 15 cc/m²·day for the multilayer films. When factored for thickness the films preferably have oxygen permeation levels of less than 40 or less than 30 cc·mil/m²·day. Other polymers may be present as additional components in the barrier layer so long as they do not raise the permeability of the barrier layer above the limit defined above.

Suitable barrier layers may be chosen from layers comprising ethylene vinyl alcohol copolymer, cyclic olefin copolymers, polyvinyl acetate, or blends thereof with polyethylene, polyvinyl alcohol, or polyamide.

The gas barrier layer of the multilayer films preferably comprises ethylene vinyl alcohol polymers and mixtures thereof. Unless specified, the term “EVOH” is to be understood both as ethylene vinyl alcohol polymers and blends of ethylene vinyl alcohol polymers with other polymers.

EVOH polymers generally have an ethylene content of between about 15 mole % to about 60 mole %, more preferably between about 20 to about 50 mole %. The density of commercially available EVOH generally ranges from between about 1.12 g/cm³ to about 1.20 gm/cm³, the polymers having a melting temperature ranging from between about 142° C. and 191° C. EVOH polymers can be prepared by well-known techniques or can be obtained from commercial sources. EVOH copolymers may be prepared by saponifying or hydrolyzing ethylene vinyl acetate copolymers. Thus EVOH may also be known as hydrolyzed ethylene vinyl acetate (HEVA) copolymer. The degree of hydrolysis is preferably from about 50 to 100 mole %, more preferably from about 85 to 100 mole %. In addition, the weight average molecular weight, M_{w}, of the EVOH component useful in the laminates of the invention, calculated from the degree of polymerization and the molecular weight of the repeating unit, may be within the range of about 5,000 Daltons to about 300,000 Daltons with about 60,000 Daltons being most preferred.

Suitable EVOH polymers may be obtained from Eval Company of America or Kuraray Company of Japan under the tradename EVAL®. EVOH is also available under the tradename SOARNOL® from Noltex L.L.C. Examples of such EVOH resins include EVAL® grades F101, E105, J102, and SOARNOL® grades DT2903, DC3203 and ET3803. Preferably the EVOH used in the invention is orientable from about 3×3 to about 10×10 stretch without loss in barrier properties from pinholing, necking or breaks in the EVOH layer.

Of special note are EVOH resins sold under the tradename EVAL® SP obtained from Eval Company of America or Kuraray Company of Japan that may be useful as components in the films of the invention. EVAL® SP is a type of EVOH that exhibits enhanced plasticity and that is suited for use in packaging applications including shrink film, polyethylene terephthalate (PET)-type barrier bottles and deep-draw cups and trays. Examples of such EVOH resins include EVAL® SP grades 521, 292 and 482. The EVAL SP grades of EVOH are easier to orient than the conventional EVAL resins. These EVOH polymers are a preferred class for use in the multilayer film compositions described herein. Without being bound to theory, it is believed that the enhanced orientability of these resins derives from their chemical structure, in particular the level of head to head adjacent hydroxyl groups in the EVOH polymer chain By head to head adjacent hydroxyl groups is meant 1,2-glycol structural units.

It has been found that EVOH polymers having a relatively high level of 1,2-glycol units in the EVOH polymer chain are particularly suited for use in multilayer film. For example about 2 to about 8 mol % 1,2-glycol structural units, preferably about 2.8 to about 5.2 mol % 1,2-glycol units may be present in the EVOH polymer chain.

Such polymers can be produced by increasing the amount of adjacent copolymerized units of vinyl acetate produced during polymerization of ethylene and vinyl acetate above the level generally used. When such polymers are hydrolyzed to form EVOH, an increased amount of head-to-head vinyl alcohol adjacency, that is, an increased amount of the 1,2-glycol structure result. It has been reported in the case of polyvinyl alcohol that the presence of the 1,2-glycol structure in polyvinyl alcohol can influence the degree of crystallinity obtained in these alcohols and thereby the tensile strength. See, for example F. L. Marten & C. W. Zvanut, Chapter 2 Manufacture of Polyvinyl Acetate for Polyvinyl Alcohol, Polyvinyl Alcohol Developments (C. A. Finch ed.) John Wiley, New York 1992.

The more orientable grades of EVOH will generally have lower yield strength, lower tensile strength and lower rates of strain hardening than other EVOH polymers of equivalent ethylene content, as measured by mol % ethylene.

The EVOH composition may optionally be modified by including additional polymeric materials selected from the group consisting of polyamides, including amorphous polyamides such as MXD6, polyvinyl acetate (PVA), ionomers, and ethylene polymers and mixtures thereof. These modifying polymers may be present in amounts up to 30 weight % of the EVOH composition.

However, the oxygen barrier effectiveness of EVOH can be reduced by the presence of moisture. Therefore, it is desirable to protect the EVOH layer from moisture from the product contained within the package or from outside the package. Notably, the gas barrier layer is positioned in the multilayer film so that at least 60%, preferably at least 65%, of the total film thickness is to the inside of the gas barrier layer.

In a preferred embodiment, the coextruded multilayer structure may comprise a layer of EVOH sandwiched between two layers of polyamide, one on each side of the EVOH layer. This leads to a maximum possible oxygen barrier and at the same time ensures excellent embedding and stabilization of the EVOH layer between the two polyamide layers as carrier layers.

Polyamides (e.g. nylon) suitable for use are generally prepared by polymerization of lactams or amino acids (e.g. nylon 6 or nylon 11), or by condensation of diamines such as hexamethylene diamine with dibasic acids such as succinic, adipic, or sebacic acid. The polyamides may also include copolymerized units of additional comonomers to form terpolymers or higher order polymers. The polyamide can include nylon 6, nylon 9, nylon 10, nylon 11, nylon 12, nylon 6,6, nylon 6,10, nylon 6,12, nylon 61, nylon 6T, nylon 6.9, nylon 12,12, copolymers thereof and blends of amorphous and semicrystalline polyamides. As used herein the term polyamide also includes polyamide nano-composites such as those available commercially under the tradename AEGIS polyamides from Honeywell International Inc. or IMPERM polyamide (nylon MXD6) from Mitsubishi Gas Chemical Company.

Preferred polyamides include polyepsiloncaprolactam (nylon 6); polyhexamethylene adipamide (nylon 6,6); nylon 11; nylon 12, nylon 12,12 and copolymers and terpolymers such as nylon 6/66; nylon 6,10; nylon 6,12; nylon 6,6/12; nylon 6/6, and nylon 6/6T, or blends thereof. More preferred polyamides are polyepsiloncaprolactam (nylon 6), polyhexamethylene adipamide (nylon 6,6), and nylon 6/66; most preferred is nylon 6. Although these polyamides are preferred polyamides, other polyamides, such as amorphous polyamides, are also suitable for use. Amorphous polyamides include amorphous nylon 61,6T available from E. I. du Pont de Nemours and Company under the tradename SELAR® PA. Other amorphous polyamides include those described in U.S. Pat. Nos. 5,053,259; 5,344,679 and 5,480,945. Additional useful polyamides include those described in U.S. Pat. Nos. 5,408,000; 4,174,358; 3,393,210; 2,512,606; 2,312,966 and 2,241,322.

Alternatively the polyamide layers may comprise blends of PA and EVOH, or PA and PVA or PA and MXD6, respectively.

As the barrier properties of EVOH may be influenced negatively by humidity, it is desirable that a moisture barrier layer be positioned between the EVOH layer and the moist contents of the package.

Forming Layer

Compositions comprising the forming layer provide the desired mechanical properties and shrink for the forming layer. They include polyolefins including polyethylene homopolymers or copolymers, or polypropylene homopolymers or copolymers.

In some embodiments, the forming layer may comprise a non-shrinking or low-shrinking polyolefin-based layer so that the film may be used, for example, as a lidding film.

In other embodiments, the forming layer may be a shrinkable layer, imparting shrinkability to the packaging film to enable the film to cling tightly around the packaged product.

The forming layer also desirably provides moisture barrier properties to the multilayer structure. Accordingly, the forming layer is positioned in the multilayer film so that it is closer to the inside surface of the film than the gas barrier layer. Notably, the forming layer is positioned so that, in its entirety, it is less than 60% of the total film thickness away from the inside surface of the film.

Polyethylenes are preferably selected from homopolymers and copolymers of ethylene. Various types of polyethylene homopolymers may be used in the forming layer; for example, ultra low density polyethylene (ULDPE), very low density polyethylene (VLDPE), low density polyethylene (LDPE), linear low density polyethylene (LLDPE), high density polyethylene (HDPE), or metallocene polyethylene (mPE). Unless specified, “polyethylene” as used herein can refer generally to polyethylene homopolymers and copolymers and to blends comprising polyethylene as the major component with other polymers.

Polyethylene may be made by any available process known in the art including high pressure gas, low pressure gas, solution and slurry processes employing conventional Ziegler-Natta, metallocene, and late transition metal complex catalyst systems.

Preferably, the polyethylene copolymer is an ethylene α-olefin copolymer wherein the ethylene copolymer may be an ethylene α-olefin copolymer which comprises ethylene and an α-olefin of three to twenty carbon atoms such as propylene, butene, hexene and octene, preferably of four to eight carbon atoms, such as butene, hexene and octene.

The density of the ethylene α-olefin copolymers ranges from 0.86 g/cm³ to 0.925 g/cm³, 0.86 g/cm³ to 0.91 g/cm³, 0.86 g/cm³ to 0.9 g/cm³, 0.860 g/cm³ to 0.89 g/cm³, 0.860 g/cm³ to 0.88 g/cm³, or 0.88 g/cm³ to 0.905 g/cm³. Resins made by Ziegler-Natta type catalysis and by metallocene or single site catalysis are included provided they fall within the density ranges so described. The metallocene or single site resins useful herein are (i) those which have an I-10/I-2 ratio of less than 5.63 and an Mw/Mn (polydispersity) of greater than (I-10/I-2)-4.63, and (ii) those based which have an I-10/I-2 ratio of equal to or greater than 5.63 and a polydispersity equal to or less than (I-10/I-2)−4.63. Preferably the metallocene resins of group (ii) may have a polydispersity of greater than 1.5 but less than or equal to (I-10/I-2)−4.63. Suitable conditions and catalysts which can produce substantially linear metallocene resins are described in U.S. Pat. No. 5,278,272. The reference gives full descriptions of the measurement of the well-known rheological parameters I-10 and I-2, which are flow values under different loads and hence shear conditions. It also provides details of measurements of the well-known Mw/Mn ratio determination, as determined by gel-permeation chromatography.

Polypropylenes include homopolymers, random copolymers, block copolymers, terpolymers of propylene, or combinations or two or more thereof. Copolymers of propylene include copolymers of propylene with other olefin such as ethylene, 1-butene, 2-butene and the various pentene isomers, etc. and preferably copolymers of propylene with ethylene, wherein propylene is the major comonomer. Terpolymers of propylene include copolymers of propylene with ethylene and one other olefin. Random copolymers (statistical copolymers) have propylene and the comonomer(s) randomly distributed throughout the polymeric chain in ratios corresponding to the feed ratio of the propylene to the comonomer(s). Block copolymers are made up of chain segments consisting of propylene homopolymer and of chain segments consisting of, for example, random copolymers of propylene and ethylene.

Polypropylene homopolymers or random copolymers can be manufactured by any known process (e.g., using Ziegler-Natta catalyst, based on organometallic compounds or on solids containing titanium trichloride). Block copolymers can be manufactured similarly, except that propylene is generally first polymerized by itself in a first stage and propylene and additional comonomers such as ethylene are then polymerized, in a second stage, in the presence of the polymer obtained during the first.

The forming layer may also comprise an ethylene copolymer. The term “ethylene copolymer” refers to a polymer comprising copolymerized units derived from ethylene and at least one additional monomer, especially a polar comonomer such as vinyl acetate, alkyl (meth)acrylate, (meth)acrylic acid or glycidyl methacrylate. The ethylene copolymer may be chosen among ethylene vinyl acetate copolymers, ethylene alkyl (meth)acrylate copolymers, ethylene alkyl (meth)acrylic acid copolymers or ionomers thereof, or combinations of two or more thereof.

In the case where the forming layer comprises an ethylene vinyl acetate (EVA) copolymer, the relative amount of copolymerized vinyl acetate units may be of from 2 to 40 weight %, preferably from 10 to 40 weight %, the weight percentage being based on the total weight of the ethylene vinyl acetate copolymer. A mixture of two or more different ethylene vinyl acetate copolymers may be used as components of the forming layer in place of a single copolymer.

The forming layer may comprise an ethylene alkyl (meth)acrylate copolymer. Ethylene alkyl (meth)acrylate copolymers are thermoplastic ethylene copolymers derived from the copolymerization of ethylene comonomer and at least one alkyl (meth)acrylate comonomer, wherein the alkyl group contains from one to ten carbon atoms and preferably from one to four carbon atoms. The relative amount of copolymerized alkyl (meth)acrylate units may be of from 0.1 to 45 weight %, preferably from 5 to 35 weight % and still more preferably from 8 to 28 weight %, the weight percentage being based on the total weight of the ethylene alkyl (meth)acrylate copolymer. Preferably, the ethylene alkyl (meth)acrylate copolymer is an ethylene methyl acrylate, ethylene ethyl acrylate, or ethylene butyl acrylate copolymer.

The forming layer may comprise an ethylene alkyl (meth)acrylic acid copolymer, or preferably an ionomer thereof.

The ethylene alkyl (meth)acrylic acid copolymer can be an E/X/Y copolymer where E represents copolymerized units of ethylene, X represents copolymerized units of a C₃ to C₈ α,β-ethylenically unsaturated carboxylic acid, and Y represents copolymerized units of an optional comonomer selected from alkyl acrylate and alkyl methacrylate.

The C₃ to C₈ α,β-ethylenically unsaturated carboxylic acid may be present of from 2 weight % to 30 weight %, preferably of from 5 weight % to 20 weight %, and most preferably of from 12 weight % to 19 weight %, based on the total weight of the ionomer. Suitable C₃ to C₈ α,β-ethylenically unsaturated carboxylic acids may be chosen among methacrylic acid and acrylic acid, with methacrylic acid being preferred.

The alkyl acrylate and/or alkyl methacrylate comonomer may optionally be present in an amount from 0.1 weight % to 40 weight %, or from 5 weight % to 35 weight %, or from 8 to 30 weight %, or from about 18 to about 30 weight % , or from about 19 to about 25 weight %, or from about 19 to about 23 weight %of the total weight of the E/X/Y copolymer.

Preferably, the alpha, beta-ethylenically unsaturated carboxylic acid is methacrylic acid. Of note are acid copolymers consisting essentially of copolymerized units of ethylene and copolymerized units of the alpha, beta-ethylenically unsaturated carboxylic acid and 0 weight % of additional comonomers; that is, dipolymers of ethylene and the alpha, beta-ethylenically unsaturated carboxylic acid. Preferred acid copolymers are ethylene methacrylic acid dipolymers.

The ethylene acid copolymers used herein may be polymerized as disclosed in U.S. Pat. Nos. 3,404,134; 5,028,674; 6,500,888; and 6,518,365.

The ionomers disclosed herein are produced from the parent acid copolymers, wherein from about 10 to about 70%, or from about 30 to about 60%, of the total carboxylic acid groups of the parent acid copolymers, as calculated for the non-neutralized parent acid copolymers, are neutralized to form carboxylic acid salts with one or more alkali metal, transition metal, or alkaline earth metal cations such as for example from sodium, zinc, lithium, magnesium, and calcium; and more preferably zinc or sodium. Thus, a preferred ionomer may be chosen among E/X copolymers where E is ethylene, X is methacrylic acid partially neutralized by zinc or sodium. Ionomers wherein the cations of the carboxy late salts consist essentially of sodium cations are notable. The parent acid copolymers may be neutralized using methods disclosed in, for example, U.S. Pat. No. 3,404,134.

Preferably, the ionomers used herein have a melt flow rate (MFR) of at least 0.5 gram/10 min, such as about 0.8 to about 20 grams/10 min as measured by ASTM D1238 at 190° C. using a 2160 g load. More preferably, the ionomer composition has a MFR of about 1 to about 10 grams/10 min, and most preferably has a MFR of about 1 to about 5 grams/10 min.

Blends comprising two or more ionomers may be used, provided that the aggregate components and properties of the blend fall within the limits described above for the ionomers.

Ionomers useful in the forming layer and the sealant layer (see below) are commercially available from E. I. du Pont de Nemours and Company, Wilmington, Del. (DuPont) under the Surlyn® tradename.

The Sealant Layer

The inside surface layer, or sealant layer, is the layer that provides the inside layer of a package prepared from the film and is closest to the packaged contents. It also provides a means for sealing or closing the package around the packaged product such as by heat sealing two portions of the sealant layer together or to the surface of another part of the package, such as sealing a lidding film to a thermoformed packaging component. The composition for the sealant layer is selected to influence the sealing capability of the inside surface layer, i.e., such that a high sealing bond strength may be achieved at a lowest possible sealing temperature.

The sealant layer may comprise one or more olefin homopolymers and/or copolymers capable of fusion bonding on another layer by conventional means of heat sealing. Preferably, the one or more olefin homopolymers and/or copolymers are chosen among polyethylene homopolymers, and/or copolymers, ethylene copolymers such as for example ethylene (meth)acrylic acid copolymers and their corresponding ionomers, and/or mixtures thereof.

Most preferably, the sealant layer comprises at least one ionomer, such as described above. When the sealant layer and the forming layer are both ionomers, there is no need for an adhesion layer between the forming layer and the sealant layer. Notably, in some structures, a single layer of ionomer may serve as both forming layer and the sealant layer.

In some embodiments, the forming layer may comprise an ionomer and the sealant layer may comprise polyethylene. Alternatively, the forming layer may comprise polyethylene and the sealant layer may comprise an ionomer. In such embodiments, an adhesion layer may be necessary to provide sufficient interlayer adhesion.

The compositions of the forming layer and the sealant layer provide a desirable water vapor barrier to protect the gas barrier layer from reduced efficiency due to the presence of vapor that may permeate through the film from the contents to the EVOH layer.

Adhesion Layers

In addition, the coextruded multilayer structure comprises one or more additional layers to serve as adhesion layers between functional layers to improve interlayer adhesion and prevent delamination of the layers. For example, such adhesion layers may be positioned between the external layer (PET) composition and the gas barrier layer composition, between the gas barrier and the forming layer, and/or between the forming layer and the sealant layer.

The adhesion layer(s) will be compositionally distinct from the forming layer and from the heat sealant layer. By compositionally distinct is meant that the number of components, the ratio of components or the chemical structure (for example, monomer ratio of polymeric components having the same monomers) of the components comprising the heat seal layer and the adhesion layer, will differ. For example, adhesion compositions described in U.S. Pat. Nos. 6,545,091, 5,217,812, 5,053,457, 6,166,142, 6,210,765 and U.S. Patent Application Publication 2007/0172614 are useful in this invention.

A preferred adhesion composition useful in the multilayer film is a multicomponent composition comprising 1) a functionalized polymer, 2) an ethylene polymer or copolymer, and optionally 3) a tackifier. These adhesion compositions are particularly suitable for use as an adhesion or “tie” layer in multilayer films, especially those that require a high degree of shrink. The adhesion compositions provide suitable adhesion between the various layers of the film and provide improved adhesion in biaxially oriented films.

The functionalized polymers useful as component 1) of the preferred multicomponent adhesion composition comprise anhydride-modified polymers and copolymers comprising copolymerized units of ethylene and a comonomer selected from the group consisting of C₄-C₈ unsaturated acids having at least two carboxylic acid groups, and cyclic anhydrides, monoesters and diesters of such acids. Mixtures of these components are also useful. The ethylene polymers or copolymers useful as component 2) of the adhesion composition comprise at least one ethylene polymer or copolymer, chemically distinct from the functionalized polymer; that is the component 1) polymer composition. By chemically distinct is meant that a) the ethylene copolymer of the second component of the adhesion comprises at least one species of copolymerized monomer that is not present as a comonomer in the functionalized polymer component or b) the functionalized polymer component of the adhesion comprises at least one species of copolymerized monomer that is not present in the ethylene copolymer of the second component of the adhesion or c) the ethylene copolymer that is the second component of the adhesion is not an anhydride-grafted or functionalized ethylene copolymer as defined above. Thus, the first and second polymers are different in chemical structure and are distinct polymer species.

The functionalized polymer may be a modified copolymer, meaning that the copolymer is grafted and/or copolymerized with organic functionalities. Modified polymers for use in the tie layer may be modified with acid, anhydride and/or epoxide functionalities. Examples of the acids and anhydrides used to modify polymers, which may be mono-, di- or polycarboxylic acids are acrylic acid, methacrylic acid, maleic acid, maleic acid monoethylester, fumaric acid, fumaric acid, itaconic acid, crotonic acid, itaconic anhydride, maleic anhydride and substituted maleic anhydride, e.g. dimethyl maleic anhydride or citrotonic anhydride, nadic anhydride, nadic methyl anhydride, and tetrahydrophthalic anhydride, or combinations of two or more thereof, maleic anhydride being preferred.

In the case where the one or more olefin homopolymers and/or copolymers are acid-modified, it may contain of from 0.05 to 25 weight % of an acid, the weight percentage being based on the total weight of the modified polymer.

Modified polymers that are suitable for use as functionalized polymer components of the preferred adhesion composition are anhydride-grafted homopolymers or copolymers.

When anhydride-modified polymer is used, it may contain from 0.03 to 10 weight %, 0.05 to 5 weight %, or 0.05 to 3% of an anhydride, the weight percentage being based on the total weight of the modified polymer. These include polymers that have been grafted with from 0.1 to 10 weight % of an unsaturated dicarboxylic acid anhydride, preferably maleic anhydride. Generally, they will be grafted olefin polymers, for example grafted polyethylene, grafted EVA copolymers, grafted ethylene alkyl acrylate copolymers and grafted ethylene alkyl methacrylate copolymers, each grafted with from 0.1 to 10 weight % of an unsaturated dicarboxylic acid anhydride. Specific examples of suitable anhydride-modified polymers are disclosed in U.S. Patent Application Publication 2007/0172614.

The functionalized polymer may also be an ethylene copolymer comprising copolymerized units of ethylene and a comonomer selected from the group consisting of C₄-C₈ unsaturated anhydrides, monoesters of C₄-C₈ unsaturated acids having at least two carboxylic acid groups, diesters of C₄-C₈ unsaturated acids having at least two carboxylic acid groups and mixtures of such copolymers. The ethylene copolymer may comprise from about 3 to about 25 weight % of copolymerized units of the comonomer. The copolymer may be a dipolymer or a higher order copolymer, such as a terpolymer or tetrapolymer. The copolymers are preferably random copolymers. Examples of suitable comonomers of the ethylene copolymer include unsaturated anhydrides such as maleic anhydride and itaconic anhydride; C₁-C₂₀ alkyl monoesters of butenedioic acids (e.g. maleic acid, fumaric acid, itaconic acid and citraconic acid), including methyl hydrogen maleate, ethyl hydrogen maleate, propyl hydrogen fumarate, and 2-ethylhexyl hydrogen fumarate; C₁-C₂₀ alkyl diesters of butenedioic acids such as dimethylmaleate, diethylmaleate, and dibutylcitraconate, dioctylmaleate, and di-2-ethylhexylfumarate. These functionalized polymer components of the adhesion composition are ethylene copolymers obtained by a process of high-pressure free radical random copolymerization, rather than graft copolymers. The monomer units are incorporated into the polymer backbone or chain and are not incorporated to an appreciable extent as pendant groups onto a previously formed polymer backbone.

Examples of epoxides used to modify polymers are unsaturated epoxides comprising from four to eleven carbon atoms, such as glycidyl (meth)acrylate, allyl glycidyl ether, vinyl glycidyl ether and glycidyl itaconate, glycidyl (meth)acrylates being particularly preferred.

Epoxide-modified ethylene copolymers preferably contain from 0.03 to 15 weight %, 0.03 to 10 weight %, 0.05 to 5 weight %, or 0.05 to 3% of an epoxide, the weight percentage being based on the total weight of the modified ethylene copolymer. Preferably, epoxides used to modify ethylene copolymers are glycidyl (meth)acrylates. The ethylene/glycidyl (meth)acrylate copolymer may further contain copolymerized units of an alkyl (meth)acrylate having from one to six carbon atoms Representative alkyl (meth)acrylates include methyl (meth)acrylate, ethyl (meth)acrylate, propyl (meth)acrylate, butyl (meth)acrylate, isobutyl (meth)acrylate, hexyl (meth)acrylate, or combinations of two or more thereof. Of note are ethyl acrylate and butyl acrylate. Preferably, modified ethylene copolymers comprised in the tie layer are modified with acid, anhydride and/or glycidyl (meth)acrylate functionalities.

The ethylene copolymers suitable for use in adhesion layers of the coextruded multilayer film structure can be produced by any means known to one skilled in the art using either autoclave or tubular reactors (e.g. U.S. Pat. Nos. 3,404,134, 5,028,674, 6,500,888, 3,350,372, and 3,756,996).

Preferably, each adhesion layer independently comprises a functionalized polymer comprising grafted polyethylene, grafted EVA copolymers, grafted ethylene alkyl acrylate copolymers or grafted ethylene alkyl methacrylate copolymers, each grafted with from 0.1 to 10 weight % of an unsaturated dicarboxylic acid anhydride; or copolymers comprising copolymerized units of ethylene and a comonomer selected from the group consisting of C₄-C₈ unsaturated acids having at least two carboxylic acid groups, and cyclic anhydrides, monoesters and diesters of such acids.

Compositions comprising olefin polymers and modified polymers thereof are commercially available under the trademarks APPEEL®, BYNEL®, ELVALOY®AC, and ELVAX® from DuPont.

The second component of the preferred adhesion composition is at least one ethylene polymer or copolymer compositionally distinct from the first functionalized polymer component. Ethylene polymers or copolymers used as the second component of the adhesion composition may be polyethylene homopolymers, copolymers of ethylene and alpha-olefins, including copolymers with propylene and other alpha-olefins. Ethylene polymers or copolymers suitable for use as the second component include high density polyethylenes, low density polyethylenes, very low density polyethylenes (VLDPE), linear low density polyethylenes, and copolymers of ethylene and alpha-olefin monomers prepared in the presence of metallocene catalysts, single site catalysts and constrained geometry catalysts (hereinafter referred to as metallocene polyethylenes, or MPE). Suitable ethylene copolymers and methods for their preparation are disclosed in U.S. Patent Application Publication 2007/0172614. The ethylene copolymer used as the second component of the adhesion composition may also comprise copolymerized units of ethylene and a polar comonomer such as vinyl acetate, alkyl acrylates, alkyl methacrylates and mixtures thereof. The alkyl groups will have from 1 to 10 carbon atoms. Additional comonomers may be incorporated as copolymerized units in the ethylene copolymer. Suitable copolymerizable monomers include carbon monoxide, methacrylic acid and acrylic acid. Ethylene alkyl acrylate carbon monoxide terpolymers are examples of such compositions, including ethylene n-butyl acrylate carbon monoxide terpolymers.

The ethylene copolymer of the second component may also be an ethylene alkyl acrylate or ethylene alkyl methacrylate copolymer. Alkyl acrylates and alkyl methacrylates may have alkyl groups of 1 to 10 carbon atoms, for example methyl, ethyl or butyl groups. The relative amount of the alkyl acrylate or alkyl methacrylate comonomer units in the copolymers can vary broadly from a few weight % to as much as 45 weight %, based on the weight of the copolymer. Mixtures of ethylene alkyl acrylate and/or alkyl methacrylate copolymers may also be used.

The adhesion composition may also include a tackifier. The presence of tackifier facilitates bond adhesion when the film is oriented and later shrunk The tackifier may be any suitable tackifier known generally in the art. For example, the tackifier may include types listed in U.S. Pat. No. 3,484,405. Suitable tackifiers include a variety of natural and synthetic resins and rosin materials. Tackifier resins that can be employed are liquid, semi-solid to solid, complex amorphous materials generally in the form of mixtures of organic compounds having no definite melting point and no tendency to crystallize. These include coumarone-indene resins, such as the para-coumarone-indene resins, terpene resins, including styrenated terpenes, butadiene-styrene resins having molecular weights ranging from about 500 to about 5,000, polybutadiene resins having molecular weights ranging from about 500 to about 5,000, hydrocarbon resins produced by catalytic polymerization of fractions obtained in the refining of petroleum, having a molecular weight range of about 500 to about 5,000, polybutenes obtained from the polymerization of isobutylene, hydrogenated hydrocarbon resins, rosin materials, low molecular weight styrene hard resins or disproportionated pentaerythritol esters, aromatic tackifiers, including thermoplastic hydrocarbon resins derived from styrene, alpha-methylstyrene, and/or vinyltoluene, and polymers, copolymers and terpolymers thereof, terpenes, terpene phenolics, modified terpenes, and combinations thereof. These latter materials may be further hydrogenated in part or in entirety to produce alicyclic tackifiers. A more comprehensive listing of tackifiers that can be employed in this invention is provided in TAPPI CA Report #55, Technical Association of the Pulp and Paper Industry, 1975, pp 13-20, which lists over 200 commercially available tackifier resins.

The thickness of each adhesion layer of the multilayer structure may be independently between 1 and 100 μm, 5 and 50 μm, or 5 to 30 μm.

The various layer compositions of the coextruded multilayer film structure may further comprise modifiers and other additives, including without limitation, plasticizers, impact modifiers, stabilizers including viscosity stabilizers and hydrolytic stabilizers, lubricants, antioxidants, UV light stabilizers, antifog agents, antistatic agents, dyes, pigments or other coloring agents, fillers, flame retardant agents, reinforcing agents, foaming and blowing agents and processing aids known in the polymer compounding art like for example antiblock agents and release agents.

These additives may be present in each layer composition independently in amounts of up to 20 weight %, preferably from 0.01 to 7 weight %, and more preferably from 0.01 to 5 weight %, the weight percentage being based on the total weight of the composition.

Representative examples of multilayer films include those described below. In the multilayer film structures the symbol “/” represents a boundary between layers. In these structures, outside to inside layers of the multilayer structure as intended to be used in a package are listed in order from left to right. Where an adhesion layer is present, that layer is designated as “tie.” Tie layer compositions in a structure may be the same or different, depending on the compositions of adjacent layers. For adjacent layers each containing ionomers, the compositions are different from each other. The structures below are not meant to be an exhaustive list of the structures of the invention and are for purposes of example. Those skilled in the art will recognize that other film structures will fall within the scope of the invention. Such structures may include one or more adhesion layers, comprising any adhesion composition, including the above-described preferred adhesion compositions. Each embodiment will have particular advantages depending on the particular packaging application.

PET/tie/PA/EVOH/PA/tie/ionomer/tie/polyethylene;

PET/tie/PA/EVOH/PA/tie/ionomer;

PET/tie/PA/E VOH/PA/tie/ionomer/ionomer;

PET/tie/PA/EVOH/PA/tie/polyethylene/tie/ionomer;

PET/tie/PA/EVOH/PA/tie/EVA/tie/ionomer;

PET/tie/PA/EVOH/PA/tie/EVA/tie/polyethylene;

PA/EVOH/PA/tie/ionomer/ionomer;

PA/EVOH/PA/tie/PE/tie/ionomer;

PA/EVOH/PA/tie/PE;

PA/EVOH/PA/tie/PP;

PA/EVOH/PA/tie/PP/tie/ionomer or PE

PP/tie/PA/EVOH/PA/tie/ionomer or PP/tie/polyethylene;

PP/tie/PA/E VOH/PA/tie/ionomer;

PP/tie/PA/E VOH/PA/tie/ionomer/ionomer;

PP/tie/PA/EVOH/PA/tie/polyethylene or PP/tie/ionomer;

PP/tie/PA/EVOH/PA/tie/EVA or ethylene alkyl acrylate/tie/ionomer;

PP/tie/PA/EVOH/PA/tie/EVA or ethylene alkyl acrylate/tie/polyethylene;

PE/tie/PA/EVOH/PA/tie/ionomer or PP/tie/polyethylene;

PE/tie/PA/EVOH/PA/tie/ionomer;

PE/tie/PA/EVOH/PA/tie/ionomer/ionomer;

PE/tie/PA/EVOH/PA/tie/polyethylene or PP/tie/ionomer;

PE/tie/PA/EVOH/PA/tie/EVA or ethylene alkyl acrylate/tie/ionomer; and

PE/tie/PA/EVOH/PA/tie/EVA or ethylene alkyl acrylate/tie/polyethylene.

The coextruded multilayer structure may be produced by a triple bubble process, which can comprise the steps of coextruding a tubular multilayer film structure comprising the layers described above, cooling the coextruded tubular multilayer film structure in a first bubble, mono- or bi-axially orienting the coextruded tubular multilayer film structure under heating in a second bubble, and relaxing the mono- or bi-axially oriented coextruded tubular multilayer film structure under heating in a third bubble. This triple bubble process allows for the manufacture of coextruded multilayer structures having excellent barrier properties as well as good mechanical properties, in combination with other functional layers.

In the triple bubble process, coextruded multilayer structure can be heated in the second bubble to a temperature above the glass transition temperature of the layer having the highest glass transition temperature and in the third bubble to a temperature that determines the shrinkage of the entire film. If the third bubble is heated to a temperature that is higher than the melting point of the sealant and adhesive resins, such as above 90 to about 120° C., thus removing the orientation from these layers, the amount of shrinkage is lowered and may be measured below 30%, or as low as 5% or less after exposing a film sample to hot (90° C.) water for 1 minute. If the third bubble is heated below 80° C., preferably below 60° C., then the shrinkage will not be significantly reduced and a heat shrinkable film will be produced. The lower the temperature that is selected for the third bubble, the more shrinkage will be retained in the film.

The coextrusion may be carried out by connecting multiple extruders processing the corresponding materials, generally in the form of granulates, to a circular or annular die to form a tubular multilayer film by methods generally known in the art.

The composition (for example, PET) making up the at least one corresponding layer in the multilayer film can be fed into a first extruder by methods known in the art to form the outermost layer of the tubular multilayer film. Similarly, the polymers making up the interior layers in the multilayer film can be fed into additional extruders to form the middle layers of the tubular multilayer film. The polymer making up the sealant layer in the multilayer film can be fed into a final extruder such as to form the inside layer of the tubular multilayer film.

The first bubble is formed on one end by the tubular multilayer film having an initial diameter D1 exiting the die, and on the other end by the set of rolls that form the hermetically closed end of the first bubble. The tubular multilayer film exiting the die is quickly cooled in a way such as to obtain a minimum amount of crystallization in the structure. Quick cooling can be obtained by quenching the exiting tubular coextruded multilayer film through a first water bath having a temperature from 0.1° C. to 50° C., preferably from 0.1° C. to 25° C. and a length of from 0.4 to 5 m, preferably from 1 to 3 m. The residence time in the water quenching bath may be adjusted to range from 1 to 20 seconds.

After cooling, a solidified tubular coextruded multilayer film can be then passed through a set of rolls which are immersed in a second water bath having a temperature from 60 to 95° C. The second water bath has a variable length of 1 to 2 meters and the residence time in this bath depending on the speed of the film line can be from 1 to 20 seconds. The water bath may be replaced by or supplemented with any suitable heating means, such as for example a hot air blower, an IR heater, heating coils or a hot air circulating oven resulting in temperatures above 95° C.

The water bath may pre-heat the solidified tubular coextruded multilayer film passing through to a temperature where it can be stretched without ripping. The solidified tubular coextruded multilayer film is heated to a temperature above the glass transition temperature of the layer having the highest glass transition temperature, such as more than 60° C., such as 60° C. to 120° C., or from 65° C. and 100° C. After being pre-heated in the second water bath, the softened tubular coextruded multilayer film is then inflated to form the second bubble. Inflating the softened tubular structure allows it to be oriented by drawing in both MD and TD directions in the second bubble at the same time.

The drawing in the MD direction can be achieved by adjusting the speed (V2) of a second set of nip rolls that form the upstream (towards the extruder) end of the second bubble and the speed (V3) of a third set of nip rolls that form the downstream (away from extruder) end of the second bubble. Generally, V3 is greater than V2, preferably 2 to 4 times greater than V2. Alternatively, the ratio given by V3/V2 is equivalent to the drawing ratio and is preferably from 2 to 3.

The drawing in the TD direction can be achieved by adjusting the pressure within the second bubble. To adjust the pressure, the distance between a first set of nip rolls that form the hermetically closed upstream (towards the extruder) end of the second bubble, and a second set of nip rolls that form the hermetically closed downstream (away from extruder) end of the second bubble can be adjusted. Reducing the distance between the two sets of nip rolls may increase the pressure, whereas increasing the distance may lower the pressure within the second bubble. After the drawing in the TD direction, the initial diameter D1 of the softened tubular multilayer film can be increased to a diameter D2, wherein the ratio between D2 and D1 is from 2 to 5, preferably from 2.5 to 3.5.

The tubular multilayer film is oriented by drawing in the second bubble under heating. The heating may be provided for by the passing of the tubular multilayer film through a heated water bath before the set of nip rolls, and may be supplemented with an alternative heat source in order to keep the tubular multilayer film in the second bubble at a temperature between the glass transition temperature and the melting point of the composition having the highest glass transition temperature, such as from 60° C. to 95° C., or 65° C. to 75° C.

In the case where the second water bath is replaced by or supplemented with an alternative heat source such as a hot air blower, IR heater or heating coils, the alternative heat source is preferably located immediately after the second set of nip rolls sealing the upstream (towards the extruder) end of the second bubble.

While passing through the third set of nip rolls, the drawn tubular coextruded multilayer film can be flattened to be more easily conveyed.

After passing through the third set of rolls the tubular coextruded multilayer film is passed through a fourth set of nip rolls that form the hermetically closed upstream (towards the extruder) end of the third bubble, and a fifth set of nip rolls that form the hermetically closed downstream (away from extruder) end of the third bubble.

The fourth and fifth set of nip rolls are separated by a distance that can be adjusted to increase or decrease the pressure within the third bubble in order to allow the previously drawn tubular coextruded multilayer film to relax in the TD direction.

Generally, this can be achieved by adjusting the pressure in the third bubble such that it is less than the pressure P1. The pressure is adjusted by modifying the distance between the fourth and the fifth set of nip rolls of the third bubble to modify the diameter D3. The relaxation ratio is given by the ratio of D3/D2, whereas D3 is usually lesser than D2 and concurrently the ratio of D3/D2 is smaller than 1, such as between 0.8 and 0.95 or between 0.85 and 0.9.

The speed of the fourth set of nip rolls and the speed of the fifth set of nip rolls may be adjusted in order to allow the previously drawn tubular coextruded multilayer film to relax in the MD direction. Generally, this can be achieved by adjusting the speed V5 of the fifth set of nip rolls such that V5 is less than V4. The relaxation ratio is given by V5/V4, whereas V5 is usually less than V4 and concurrently the ratio of V5/V4 is smaller than 1, such as from 0.8 to 0.95, more preferably from 0.85 to 0.9.

The temperature of the third bubble, the pressure and the ratio of V5/V4 may be adjusted individually or in parallel to achieve a tubular coextruded multilayer film exhibiting a thermal shrink ranging from 1 to 60%, 5 to 50%, 10 to 40%, or 15 to 30%, when measured at a temperature from 40 to 100° C.

The temperature of the third bubble can be adjusted by an IR heater, steam or heated air heater, and can be chosen depending on the desired thermal shrink for the finished tubular coextruded multilayer film in MD direction and/or TD direction, upon heating to a temperature exceeding the one set for the third bubble. On the other hand, the tubular coextruded multilayer film may not exhibit any thermal shrink upon heating to a temperature less than the one set for the third bubble.

The tubular multilayer film is relaxed in the third bubble B3 under heating. In order to keep the tubular multilayer film at a temperature between the glass transition temperature of the composition with the highest glass transition temperature and its melting point in the third bubble, an appropriate heating means may be used, such as an IR heater, steam or heated air heater. Preferably, the temperature of the coextruded multilayer film in the third bubble is higher than in the second bubble, such as from 70° C. to 120° C.

Depending on the settings chosen in the third bubble, the coextruded multilayer film structure may exhibit a thermal shrinkage of from 1% to 60%, 5 to 50%, 10 to 40%, 15 to 30%, or 30% to 50%, or 30 to 60%, when exposed to a temperature of about 90° C. for 1 minute.

Depending on the settings chosen in the third bubble, the coextruded multilayer film structure may exhibit a thermal shrinkage of less than 30% or less than 15%, such as from 1 to 10%, 1 to 8%, 1 to 7%, 1 to 5%, or 1 to 3% when exposed to a temperature of about 120° C. or greater for 1 minute.

After passing through the fifth set of nip rolls, the tubular coextruded multilayer film is passed through a set of rolls, flattened and stored on a roll.

Optionally, the tubular coextruded multilayer film exiting the fifth set of nip rolls can be slit on one side by a slitting knife to yield a planar coextruded multilayer film that can be stored on a roll.

Alternatively, the coextruded multilayer film as described herein can be oriented by tenter frame orientation. The invention provides a process for preparing the food casing or food film as described above comprising coextruding in a flat die a multilayer molten flow comprising the layer structure as described above; cooling the multilayer film structure on a casting roll to produce a multilayer flat structure; orienting the multilayer structure under heating in an oven of a tenter frame to produce an oriented multilayer structure; and relaxing the oriented flat multilayer structure under heating in an oven of a tenter frame.

The film according to the present invention can be obtained by melt extruding the polymers or polymer blends used for each layer through a flat die, cooling quickly the multilayer sheet exiting from the extrusion die by means of a chill roll, reheating this flat sheet to the suitably selected orientation temperature, and biaxially stretching the heated tape at a stretching ratio of at least 2:1 in each direction, by a tenter apparatus, optionally stabilizing the obtained bi-axially oriented film by an annealing or a heat-setting step and finally cooling the thus obtained bi-axially oriented, multi-layer film.

Preferably the biaxial stretching will be carried out simultaneously as it may be possible in this way to reach much higher stretching ratios, even when the core EVOH-containing layer does not comprise plasticizers. It may be possible to easily reach stretching ratios of 5:1 in each direction. It is possible that also higher stretching ratios, such as for instance 5.5:1, 6:1, or 6.5:1, could be applied, at least in one direction, possibly by suitably adjusting the stretching conditions and/or the composition of the core layers.

Tenter frame orientation is well known in the art. Briefly, orientation in the machine direction is accomplished by passing the heated film through a section of rolls in parallel arrangement wherein the takeup roll is driven at a faster rate than the first feed rolls. The transverse orientation is accomplished by passing the heated film through a tenter frame having a chain of tenter clips on each side of the film. The film is directed between the parallel rows of tenter clips and these tenter clips grasp the edges of the material and move outwardly to stretch the film transversely.

Advantageously a food casing or food film for food packaging is provided which alternatively allows for a defined high shrinkage of up to 70% or, in contrast, a defined low shrinkage as low as 0%.

By means of the layer structures it is advantageously possible to achieve a particularly high shrinkage for shrink bags etc., amounting to at least 30% to 70%, preferably at least 40% to 60%, when heated to a temperature of 90° C.

It is also advantageously possible to achieve a particularly low shrinkage for sealable films etc., amounting to 0 to 30% at the most, preferably 2 to 5%, when heated to a temperature of about 90° C.

Thanks to the extremely well-formed oxygen barrier, the multilayer structure furnishes a food packaging material whereby even goods that are particularly sensitive to air are not subject to color changes or even to the risk of aging or changing their taste or aroma due to the entry of oxygen, even over long storage periods. The particularly pronounced oxygen barrier obtained as a result of the layer component EVOH ensures excellent preservation over several weeks without any quality decrease of the packaged foods.

An excellent water vapor barrier may be made available, which is crucial particularly in the case of meats or other foods that need to be kept fresh. Foodstuffs packaged with the food casing or food film described herein thus stay fresh for a particularly long time. Owing to the low water vapor permeability, the weight losses involved in storing the foods and particularly in storing meats remain particularly low.

The coextruded multilayer film structure may be used in particular in packaging applications, but may also be used in non-packaging applications such as for example, manufacture of tapes or textiles for building, landscaping, or garment applications. For example, the coextruded multilayer film structure may be used in the packaging article as a lidding film or as a shrink film.

Also provided is an article comprising a coextruded multilayer film structure disclosed above.

The food casing or food film described herein may be used as food packaging having the form of a shrink bag, sealable film, lidding film, wrapping film, or the like.

Notable embodiments include:

The food casing or food film wherein the outside surface layer comprises polyethylene terephthalate polyester.

The food casing or food film wherein the outside surface layer comprises polyamide.

The food casing or food film wherein the outside surface layer comprises polyethylene or polypropylene.

The food casing or food film wherein the gas barrier layer comprises ethylene vinyl alcohol polymer.

The food casing or food film wherein the gas barrier layer comprises ethylene vinyl alcohol polymer sandwiched between two layers of polyamide.

The food casing or food film wherein the polyamide comprises nylon 6, nylon 9, nylon 10, nylon 11, nylon 12, nylon 6,6, nylon 6,10, nylon 6,12, nylon 6I, nylon 6T, nylon 6.9, nylon 12,12, MXD6, nylon 6I,6T, copolymers thereof or blends of amorphous and semicrystalline polyamides.

The food casing or food film wherein the polyamide comprises nylon 6, nylon 6,6 or nylon 6/66.

The food casing or food film wherein the forming layer comprises polyethylene homopolymer or copolymer.

The food casing or food film wherein the forming layer comprises an ethylene copolymer comprising copolymerized units derived from ethylene and at least one additional polar comonomer.

The food casing or food film wherein the ethylene copolymer comprises ethylene vinyl acetate copolymer, ethylene alkyl (meth)acrylate copolymer, ethylene alkyl (meth)acrylic acid copolymer or ionomer thereof, or combination of two or more thereof.

The food casing or food film wherein the ethylene copolymer comprises an ionomer.

The food casing or food film wherein the inside surface layer comprises a polyethylene homopolymer or copolymer.

The food casing or food film wherein the inside surface layer comprises an ethylene alkyl (meth)acrylic acid copolymer or ionomer thereof.

The food casing or food film wherein the inside surface layer comprises an ionomer.

The food casing or food film wherein each adhesion layer independently comprises a functionalized polymer comprising grafted polyethylene, grafted EVA copolymers, grafted ethylene alkyl acrylate copolymers or grafted ethylene alkyl methacrylate copolymers, each grafted with from 0.1 to 10 weight % of an unsaturated dicarboxylic acid anhydride; or copolymers comprising copolymerized units of ethylene and a comonomer selected from the group consisting of C₄-C₈ unsaturated acids having at least two carboxylic acid groups, and cyclic anhydrides, monoesters and diesters of such acids.

The food casing or food film wherein each adhesion layer independently additionally comprises at least one ethylene polymer or copolymer, chemically distinct from the functionalized polymer, and optionally a tackifier.

The food casing or food film comprising the following layer structure from the outside to the inside:

an outside surface layer comprising polyester;

a layer comprising a first adhesion layer;

a gas barrier layer comprising ethylene vinyl alcohol copolymer sandwiched between two layers of polyamide;

a layer comprising a second adhesion layer;

an optionally shrinkable forming layer comprising an ionomer;

an optional layer comprising a third adhesion layer; and

an inside surface layer comprising a polyethylene homopolymer or copolymer, or an ethylene alkyl (meth)acrylic acid copolymer or ionomer thereof.

The food casing or food film wherein the inside surface layer comprises an ionomer and the third adhesion layer is not present.

The food casing or food film wherein the inside surface layer comprises a polyethylene homopolymer or copolymer and the third adhesion layer is present.

The food casing or food film having the shape of a sheet or a tube which is produced by a blown film coextrusion process and biaxially oriented by the triple-bubble process.

The food casing or food film having the shape of a sheet which is produced by a cast film coextrusion process and biaxially oriented by tenter frame orientation.

The food casing or food film characterized in that the food casing or food film is fashioned as a food packaging having the form of a shrink bag, a sealable film, or a wrapping film.

The food casing or food film wherein the film exhibits 30 to 60% thermal shrinkage when exposed to a temperature of about 90° C. for 1 minute.

The food casing or food film wherein the film exhibits a thermal shrinkage of less than 30% when exposed to a temperature of about 120° C. for 1 minute.

A process for preparing the food casing or food film comprising coextruding a multilayer molten flow comprising the layer structure described above; cooling the multilayer film structure in a first bubble to produce a tubular multilayer structure; orienting the tubular multilayer structure under heating in a second bubble to produce an oriented tubular multilayer structure; and relaxing the oriented tubular multilayer structure under heating in a third bubble.

### EXAMPLES

### Materials Used

PET: polyethylene terephthalate available commercially as Cumastretch™ FX from Dufor Resins B.V., Netherlands.
PA: a blend of 80 weight % of nylon6/66 with melting point of 191-201° C. and relative viscosity of 3.99 to 4.17 cP (96% H₂SO₄) available commercially as UBE 5033B from Celanese and 20 weight % of nylon 6I/6T available commercially from DuPont under the tradename Selar® PA 3426.
EVOH: ethylene vinyl alcohol available commercially as EVAL® F171 from Kuraray
ION-1: an ethylene methacrylic acid (10 weight %) copolymer neutralized with sodium (54%), MI of 1.3 g/10 min.
ION-2: an ethylene methacrylic acid (12 weight %) copolymer neutralized with zinc (38%), MI of 1.8 g/10 min.
PE: a polyethylene copolymer with density of 0.902 g/cm³, MI of 1 g/10 min, m.p. of 99° C. and Vicat softening point of 86° C., available commercially as Affinity™ 1880G from Dow Chemical Company.
Tie-1: a blend adhesive composition comprising linear low density polyethylene and an anhydride modified linear low density polyethylene with density of 0.91 g/cm³, MI of 1.7 g/10 min, m.p. of 103° C., available commercially as Bynel® 41E687 from DuPont.
Tie-2: a blend adhesive composition comprising an ethylene methacrylate copolymer, very low density polyethylene and anhydride modified ethylene alkyl acrylate copolymers with density of 0.93 g/cm³, MI of 1.6 g/10 min, m.p. of 92° C., available commercially as Bynel® 21E787 from DuPont.

Melt Index (MI), the mass rate of flow of a polymer through a specified capillary under controlled conditions of temperature and pressure, was determined and/or reported according to ASTM 1238 at 190° C. using a 2160 g weight, in g/10 minutes.

Coextruded multilayer films were produced on a triple bubble (3B) manufacturing line from Kuhne Anlagenbau GmbH, Germany using the materials summarized in Table 1 and the conditions described below. In Table 1 layer 1 is the outside surface layer of the tubular bubble, layer 11 is the inside surface layer of the bubble and layers 2-10 are interior layers. When the same material comprises contiguous layers of the structure in Table 1, such as layers 3, 4 and 5 in the C1 film, they will appear to be a single layer in the final film structure. The outside layer of the bubble will be the outside layer (farthest from the packaged goods) of the packaging film and the inside layer will be the inside layer (nearest the packaged goods).

The barrier triplet layers, PA/EVOH/PA, in the Comparative Example Cl film are located close to the inside of the packaging film and the ionomer forming layer is close to the outside of the film. The Example films place the barrier triplet layers close to the outside of the film and the ionomer forming layer close to the inside of the film. In Example 1, a single thick layer of ionomer serves as both forming layer and sealant layer. In Example 2, a thick layer of ionomer serves as a forming layer and a different ionomer serves as the sealant layer. In Example 3, a thick layer of ionomer serves as a forming layer, a polyethylene serves as the sealant layer and an adhesion layer is present between the ionomer and the polyethylene. Except for the differences in sealing layers and different adhesion layers to accommodate the different layer compositions, the major difference between the Comparative film and the Example films was the relative position of the gas barrier layers in the overall structure. Each of the films had similar amounts of each composition, so the difference between the Comparative film and the Examples can be largely ascribed to the positions of the barrier layers in the films.

TABLE 1

| | Example | | | | | | | | | | | |
|---|---|---|---|---|---|---|---|---|---|---|---|---|
| | C1 | | | 1 | | | 2 | | | 3 | | |
| | | Thickness | | | Thickness | | | Thickness | | | Thickness | |
| Layer | Composition | μm | % | Composition | μm | % | Composition | μm | % | Composition | μm | % |
| 1 | PET | 4.2 | 8 | PET | 4.1 | 8 | PET | 4.1 | 8 | PET | 4.2 | 8 |
| 2 | Tie-1 | 2.6 | 5 | Tie-2 | 3.1 | 6 | Tie-2 | 3.1 | 6 | Tie-2 | 3.1 | 6 |
| 3 | ION-1 | 6.3 | 12 | PA | 2.5 | 5 | PA | 2.5 | 5 | PA | 2.6 | 5 |
| 4 | ION-1 | 6.3 | 12 | EVOH | 3.1 | 6 | EVOH | 3.1 | 6 | EVOH | 3.1 | 6 |
| 5 | ION-1 | 6.3 | 12 | PA | 2.5 | 5 | PA | 2.5 | 5 | PA | 2.6 | 5 |
| 6 | Tie-1 | 3.1 | 6 | Tie-1 | 3.1 | 6 | Tie-1 | 3.1 | 6 | Tie-1 | 2.6 | 5 |
| 7 | PA | 2.6 | 5 | ION-1 | 6.1 | 12 | ION-1 | 5.1 | 10 | ION-1 | 6.3 | 12 |
| 8 | EVOH | 2.6 | 5 | ION-1 | 6.1 | 12 | ION-1 | 5.1 | 10 | ION-1 | 6.3 | 12 |
| 9 | PA | 2.6 | 5 | ION-1 | 6.1 | 12 | ION-1 | 5.1 | 10 | ION-1 | 6.3 | 12 |
| 10 | Tie-1 | 3.1 | 6 | ION-1 | 6.1 | 12 | ION-1 | 5.1 | 10 | Tie-1 | 2.6 | 5 |
| 11 | ION-2 | 12.5 | 24 | ION-1 | 8.1 | 16 | ION-2 | 12.2 | 24 | PE | 12.6 | 24 |
| total | | 52.3 | 100 | | 50.9 | 100 | | 51.0 | 100 | | 52.4 | 100 |
| Percent of total thickness | | | 30 | | | 70 | | | 70 | | | 70 |
| inside the gas barrier layer | | | | | | | | | | | | |

Eleven extruders were connected to a circular die to coextrude a tubular multilayer structure having 11 layers, some of which combined with contiguous layers of identical composition to form a single thick layer.

The circular die was set to a temperature of 230° C. and configured to extrude the layers in the order summarized in Table 1.

The tubular multilayer structure exiting the circular die was directed in to a water bath having a temperature of about 10° C. for quenching and run through a calibrator setting the diameter to 74.5 mm. The tubular multilayer structure was then conveyed through rollers through a zone heated by an IR heater to a temperature of 88° C. in order to preheat the structure, and was subsequently biaxially oriented in both transverse direction (TD) and machine direction (MD) simultaneously. The heated tubular multilayer structure was then inflated from a diameter of 74.5 mm to a diameter of 245 mm, resulting in a stretch ratio of 3.29 in transverse direction. Simultaneously orientation in machine direction was achieved by heating and stretching the heated tubular multilayer structure by setting the downstream rollers to 2.5 times the speed of the upstream rollers resulting in a stretch ratio of 2.5 in the machine direction.

The now biaxially oriented tubular multilayer structure was then flattened, cooled to room temperature and conveyed by rollers, and subsequently subjected to relaxation in both machine direction (MD) and transverse direction (TD) simultaneously.

Relaxation in the transverse direction was achieved by heating the tubular multilayer structure to a temperature of 97° C. with a hot air blower, and inflating the heated tubular multilayer structure and allowing it to reduce its diameter of from 245 mm to a diameter of 191 mm, resulting in a stretch ratio of 0.78 in transverse direction.

Simultaneously, relaxation in the machine direction was achieved by heating the tubular multilayer structure to a temperature of 97° C. with a hot air blower, and setting the downstream rollers to 0.92 times the speed of the upstream rollers, thus allowing the heated tubular multilayer structure to retract, resulting in a stretch ratio of 0.92 in machine direction. After relaxation, the film had net TD orientation of 2.57 and MD orientation of 2.3. The resulting film has low shrinkage when heated to a temperature greater than 90° C. for one minute.

The thus obtained tubular biaxially oriented coextruded multilayer film structure was then slit on one side by a slitting knife to yield a flat coextruded multilayer film structure that was wound on a roll.

The properties of the films are summarized in Table 2.

Oxygen Transmission Rate was measured at 23° C. with a relative humidity of 50% or 80% at the PET side and 50% or 80% at the sealant (inner bubble) side respectively according to ASTM D3985. The samples were conditioned for two hours at the respective conditions before the measurements were taken. Permeation rate was calculated by normalizing the transmission of each film for its thickness.

Curl was assessed by taking small circular samples of film, laying them flat and qualitatively determining visually the amount of curl immediately following formation and quantitatively one week after preparation. In some cases the film curled toward the outside layer and in some cases toward the inside layer. The amount of curl is the ratio of the final diameter (Dc) across the curled film sample after curling to the initial diameter (Di) of the film sample (the flat width). The percentage of curl is calculated according to the formula below, using an example calculation

Ratio: Dc/Di=30/115=0.26%

% of curling=((Di−Dc)*100)/Di=73.9%

Haze was tested according to ASTM D1003-13.

Seal strength was assessed by heat sealing sealant layers together at temperatures between 90° C. and 160° C. and pressure of 4MPa using standard heat seal techniques. The layers were then peeled apart using a t-peel according to ASTM D1876. The stress versus strain for each film at 100° C. was plotted and the maximum peak force, median value and width of seal window are reported in Table 4. Seal width is a description of the curve of the seal strength measurement. In the case of the example films the curve shows high width exhibiting high seal strength. In the case of the comparative example there is only a narrow peak followed by sudden drop of the seal value indicating delamination of the film.

Delamination was assessed by judging the integrity of the film when separating the films after sealing.

TABLE 2

| | | Example | | | |
|---|---|---|---|---|---|
| | | C1 | 1 | 2 | 3 |
| Thickness (mil) | | 2.22 | 2.22 | 2.17 | 2.12 |
| O₂ Transmission Rate | | 15.6 | 10.25 | 11.1 | 11.3 |
| (cc/m² · day) | | | | | |
| O₂ Permeation rate | 50%/80% | 35.1 | 22.8 | 26.3 | 24.1 |
| (cc · mil/m² · day) | | | | | |
| RH outside/inside | 50%/50% | 28 | 25 | 23 | 23 |
| | 80%/80% | 27 | 39 | 36 | 38 |
| Initial Curl | | low | lowest | low | high |
| Final Curl (%) | | 73 | 79 | 89 | 89 |
| Haze (%) | | 8.9 | 3.9 | 8 | 11 |
| Seal Strength | | 4.5 | 10 | 14 | 8 |
| Max peak (N/15 mm) | | | | | |
| median value (N/15 mm) | | 1 | 4 | 12 | 4 |
| Width of seal Window (mm) | | 1 | 15 | 20 | 20 |
| Delamination (yes/no) | | yes | no | no | no |

The data in Table 2 shows that all the Example films have significantly lower oxygen transmission and permeation rates than Comparative Example C1 in the event that the humidity in the inside of the package is high and the humidity on the outside is not higher than 50%, which is the case for fresh meat, fish and other high moisture content products. The difference becomes negligible at low relative humidity levels on both sides of the package and is actually unfavorable at high humidity levels outside of the package due to the higher exposure of the barrier layer to the outside moisture. The examples therefore show clearly that protecting the moisture sensitive gas barrier layer from the inside package humidity leads to improved barrier performance of the overall package. Protection of the moisture sensitive gas barrier layer from outside moisture could be improved by using polypropylene or polyethylene as the outside surface film instead of PET. Each Example also has better seal strength when sealed to itself, with a higher peak maximum and wider seal window. Each Example film showed no delamination (when sealed to itself) compared to the comparative film C1. Example 1 also showed less haze than C1.

1. A multilayer food casing or food packaging film that is optionally shrinkable and that comprises the following layer structure, positioned in order from the outside to the inside with respect to a package prepared from the multilayer food casing or food packaging film:
an outside surface layer comprising one or more polymers selected from the group consisting of a polyester, a polyimide, a polystyrene, a polycarbonate, a poly(methyl methacrylate), a cyclic olefin copolymer, a polypropylene, and a high density polyethylene;
an optional layer comprising a first adhesion layer;
a gas barrier layer comprising one or more polymers selected from the group consisting of an ethylene vinyl alcohol copolymer, cyclic olefin copolymers, a polyvinyl acetate, and a blend of the ethylene vinyl alcohol copolymer, the cyclic olefin copolymer, or the polyvinyl acetate with a polyethylene, a polyvinyl alcohol, or a polyimide;
a second optional layer comprising a second adhesion layer;
a forming layer comprising a polyethylene homopolymer or copolymer, or a polypropylene homopolymer or copolymer, or an ethylene copolymer comprising copolymerized units derived from ethylene and at least one additional polar comonomer, wherein said forming layer is optionally shrinkable;
a third optional layer comprising a third adhesion layer; and
an inside surface layer comprising a polyethylene homopolymer or copolymer, or an ethylene alkyl (meth)acrylic acid copolymer or an ionomer of the ethylene alkyl (meth)acrylic acid copolymer;
wherein the sum of the thicknesses of the optional second layer, the forming layer, the optional third layer and the inside surface layer is at least 60% of the total thickness of the multilayer food casing or food packaging film.

2. The multilayer food casing or food packaging film according to claim 1, wherein the outside surface layer comprises a polyethylene terephthalate polyester, a polyamide, a polyethylene or a polypropylene.

3. The multilayer food casing or food packaging film according to claim 1, wherein the gas barrier layer comprises an ethylene vinyl alcohol copolymer or an ethylene vinyl alcohol copolymer sandwiched between two layers of a polyamide.

4. The multilayer food casing or food packaging film according to claim 1, wherein the polyamide comprises nylon 6, nylon 9, nylon 10, nylon 11, nylon 12, nylon 6,6, nylon 6,10, nylon 6,12, nylon 6I, nylon 6T, nylon 6.9, nylon 12,12, MXD6, nylon 6I,6T, copolymers thereof or blends of amorphous and semicrystalline polyamides.

5. The multilayer food casing or food packaging film according to claim 1, wherein the forming layer comprises the polyethylene homopolymer or copolymer.

6. The multilayer food casing or food packaging film according to claim 1, wherein the forming layer comprises the ethylene copolymer comprising copolymerized units derived from ethylene and at least one additional polar comonomer.

7. The multilayer food casing or food packaging film according to claim 1, wherein the inside surface layer comprises the polyethylene homopolymer or copolymer and the third adhesion layer is present.

8. The multilayer food casing or food packaging film according to claim 1, wherein the inside surface layer comprises the ethylene alkyl (meth)acrylic acid copolymer or the ionomer, and the third adhesion layer is not present.

9. The multilayer food casing or food packaging film according to claim 1, wherein each adhesion layer independently comprises a functionalized polymer comprising grafted polyethylene, grafted EVA copolymers, grafted ethylene alkyl acrylate copolymers or grafted ethylene alkyl methacrylate copolymers, each grafted with from 0.1 to 10 weight % of an unsaturated dicarboxylic acid anhydride; or copolymers comprising copolymerized units of ethylene and a comonomer selected from the group consisting of C₄-C₈ unsaturated acids having at least two carboxylic acid groups, and cyclic anhydrides, monoesters and diesters of such acids; optionally wherein each adhesion layer independently additionally comprises at least one ethylene polymer or copolymer, chemically distinct from the functionalized polymer, and optionally a tackifier.

10. The multilayer food casing or food packaging film according to claim 1, comprising the following layer structure:
the outside surface layer comprising the polyester;
the first adhesion layer;
the gas barrier layer comprising the ethylene vinyl alcohol copolymer sandwiched between two layers of a polyimide;
the second adhesion layer;
the forming layer comprising the ionomer;
optionally, the third adhesion layer; and
the inside surface layer comprising the polyethylene homopolymer or copolymer, or the ethylene alkyl (meth)acrylic acid copolymer or the ionomer of the ethylene alkyl (meth)acrylic acid copolymer.

11. The multilayer food casing or food packaging film according to claim 1, having the shape of a sheet or a tube, wherein said sheet or tube is produced by a blown film coextrusion process and biaxially oriented by the triple-bubble process, or wherein said sheet or tube is produced by a cast film coextrusion process and biaxially oriented by tenter frame orientation.

12. The multilayer food casing or food packaging film according to claim 1, having the form of a shrink bag, a sealable film, or a wrapping film.

13. The multilayer food casing or food packaging film according to claim 1 that exhibits 30 to 60% thermal shrinkage when exposed to a temperature of about 90° C. for 1 minute.

14. The multilayer food casing or food packaging film according to claim 1 that exhibits a thermal shrinkage of less than 30% when exposed to a temperature of about 120° C. for 1 minute.

15. A process for preparing the multilayer food casing or food packaging film according to claim 1, comprising coextruding a multilayer molten flow; cooling the multilayer film structure in a first bubble to produce a tubular multilayer structure; orienting the tubular multilayer structure under heating in a second bubble to produce an oriented tubular multilayer structure; and relaxing the oriented tubular multilayer structure under heating in a third bubble.

16. A process for preparing the multilayer food casing or food packaging film according to claim 1, comprising coextruding in a flat die a multilayer molten flow; cooling the multilayer film structure on a casting roll to produce a multilayer flat structure; orienting the multilayer flat structure under heating in an oven of a tenter frame to produce an oriented flat multilayer structure; and relaxing the oriented flat multilayer structure under heating in an oven of a tenter frame.

17. The multilayer food casing or food packaging film according to claim 6, wherein the ethylene copolymer comprises one or more polymers selected from the group consisting of an ethylene vinyl acetate copolymer, an ethylene alkyl (meth)acrylate copolymer, an ethylene alkyl (meth)acrylic acid copolymer, and an ionomer of the ethylene alkyl (meth)acrylic acid copolymer.

18. The multilayer food casing or food packaging film according to claim 17, wherein the ethylene copolymer comprises the ionomer.

19. The multilayer food casing or food packaging film according to claim 11, having a drawing ratio in the machine direction of from 2 to 3, or a drawing ratio in the transverse direction of from 2 to 5.

20. The multilayer food casing or food packaging film according to claim 11, having a relaxation ratio in the machine direction of less than 1, or a relaxation ratio in the transverse direction of less than 1.
